(19) United States
(12) Patent Application Publication
(10) Pub. No.: US 2025/0209101 A1
(43) Pub. Date: Jun. 26, 2025

(54) AI Assistant That Gives Moderated Responses to Queries

(71) Applicant: Knostic, Inc., Herndon, VA (US)

(72) Inventors: Sounil Yu, Reston, VA (US); Eddie Aronovich, Ramat ha-Sharon (IL)

(21) Appl. No.: 19/000,193

(22) Filed: Dec. 23, 2024

Related U.S. Application Data
(60) Provisional application No. 63/632,426, filed on Apr. 10, 2024.
(60) Provisional application No. 63/626,558, filed on Jan. 30, 2024.
(60) Provisional application No. 63/614,713, filed on Dec. 26, 2023.

(51) Int. Cl. G06F 16/334; G06F 16/335; G06F 21/62

(52) U.S. Cl. CPC G06F 16/3347; G06F 16/335; G06F 21/6218

(57) ABSTRACT

A computerized method for handling queries to an artificial intelligence (AI) assistant in the setting of an organization. The AI assistant comprises a pre-trained large language model (LLM). The AI assistant may access a knowledge repository comprising documents that represent the organization's knowledge base. The AI assistant may access a user profile database that comprises user attributes of users of the AI assistant. The AI assistant receives a query from a user and generates a response to the query with moderation of the response according to the user's ‘need-to-know’. Also disclosed are computerized systems that implement the method of providing a moderated response to the query.

### TECHNICAL FIELD

This invention generally relates to artificial intelligence chatbot systems.

### BACKGROUND

With the rapid advancement of artificial intelligence (AI) technologies, there has been a growing interest in using AI-powered chatbots to facilitate communication and information retrieval. AI chatbots are automated systems designed to simulate conversation with human users, provide assistance, information, or perform tasks based on natural language inputs. Traditionally, AI chatbots have been employed in various domains, including customer service, virtual assistants, and information retrieval. These systems often rely on pre-programmed responses or external databases to generate replies to user queries.

However, many companies have a wealth of internal knowledge and information stored within their databases, intranets, etc. Accessing and using this knowledge base accurately and in real-time to assist employees has posed a significant challenge. In particular, one challenge that could arise is the need to consider a user's access level to the knowledge base within an AI chatbot. This access level could vary according to user roles, permissions, and organizational needs.

Different users within the company might require different levels of access to the knowledge base. For instance, an entry-level employee might need access to basic procedures and information, while a manager or executive might require access to more sensitive or strategic data. Access to certain types of information could be restricted based on the principle of ‘need-to-know’. Not all employees may require access to highly confidential or specialized data. Access restrictions based on job functions or specific project involvement can ensure that sensitive information remains protected. Thus, there is a need for an AI chatbot that adheres to the principle of ‘need-to-know’.

### SUMMARY

This invention handles queries made to an artificial intelligence (AI) assistant in an organization setting. Examples of organizations include corporations, non-profits, universities, business enterprises, government agencies, etc. The organization comprises multiple persons (e.g. at least 8 individual persons). There could be at least 8 individual users of the AI assistant.

The AI assistant comprises a large language model (LLM) that is pre-trained on a large body of public information. There are various such LLM's that are available for use such as GPT-4 (as implemented by ChatGPT), Gemini (as implemented by Google Bard), and Claude. Multi-modal LLMs could also be used (e.g. for analysis of audio or video content). The AI assistant may use multiple (two or more) LLMs.

User Status Attributes. The AI assistant works in conjunction with a user profile database, which comprises a collection of user status attributes. The user profile database could be part (contained in) the knowledge repository or separate therefrom. Status attributes indicate a user's status in the organization. Examples of user status attributes include job title, role, function, job objectives, position in the hierarchy, team, department, data access privileges, geographic location, preferred language, domain expertise, etc. For example, based on their status in the organization, different users may have different levels or different types of privilege to the body of institutional knowledge.

The user status attributes may be in any suitable data format such as human-readable text, code, embedding of numeric vectors, etc. The user profile database may also contain other items of information about the users, including those that could be useful to the AI assistant in generating a response to user queries. The user profile database could contain user status attributes for at least 8 individual users of the AI assistant. The user profile could also contain types of information to which the user is allowed query access or those which are denied to the user.

Knowledge Repository. The AI assistant works in conjunction with the organization's institutional knowledge base. Examples of information items in the knowledge base include memos, emails, messages, meeting notes, marketing materials & data, product technical specifications, software code, manuals, financial data, etc. The knowledge base includes information that is confidential or proprietary to the organization. The information items in the knowledge base are captured and stored (electronically) as documents in a knowledge repository. Herein, the items of stored electronic information are referred to as “documents”. The documents could be in any electronic format and could contain any suitable type of data such as text, images, video, audio, event logs, etc. The documents could be stored in any suitable manner, such as internal SharePoint sites, internal websites, shared network drives, NAS (network attached storage) drives, cloud storage drives, etc.

The knowledge repository may be provided to the LLM in any suitable way to give supplemental context for responding to queries. In some embodiments, the LLM is pretrained on the knowledge repository. In some embodiments, the AI assistant retrieves one or more documents from the knowledge repository as supplementary context for the LLM. The knowledge repository could be represented in a vector database. For example, the documents of the knowledge repository could be embedded as vectors in the vector database. These vectors represent the content of the documents. This technique of augmenting the LLM with the vector database could be performed in a conventional manner. Each of the documents in the knowledge repository are converted into numeric vectors and these are stored in the vector database, and optionally, with indexing to the documents in the knowledge repository. The vectors could further represent metadata about the documents (e.g. type of data, origin, organizational affiliation, date, permissions, etc).

Document Retrieval. In some cases, the LLM is already pretrained on the knowledge repository. In some cases, the AI assistant retrieves one or more documents from the knowledge repository that are relevant to the user's query. This document retrieval could be performed as follows. The user's query is converted into a query vector. The AI assistant selects one or more documents from the knowledge repository by doing a vector search. This is performed by comparing the query vector to the document vectors in the vector database. Based on the similarity of the query vector to the document vectors, the AI assistant selects one or more documents that are relevant to the query. By the document indexing provided in the vector database, the AI assistant retrieves the selected document(s). The number of document(s) selected is fewer than the number of documents indexed by the vector database or stored in the knowledge repository.

Invoking the LLM With Context. In some embodiments, the AI assistant invokes the LLM with context for responding to the user's query, as described in this section. The AI assistant feeds the user's query to the LLM. This may optionally include the selected document(s) as supplemental context. LLM returns an initial response to the user's query. For certain users, the AI assistant does not give this initial response to the user. Instead, the AI assistant gives the user a moderated response that is different from the initial response and that is appropriate for the user's attributes. Examples of how the initial response could be moderated include making it more vague, more ambiguous, more equivocal, more superficial, less precise, less detailed, less specific, less data, with omissions, etc.

For generating the moderated response, the AI assistant invokes the same LLM as above with an instruction to restate the initial response with moderating context. The moderating context may comprise the user's status attributes. The AI assistant feeds the moderating context to the LLM along with the instruction to restate the initial response in view of the moderating context. The LLM generates a moderated response, which is given to the user. This moderated response could be given in any suitable manner such as displaying on the monitor screen, printing on paper, sending a message or email to the user, etc. In some cases, the user is given the moderated response but not the initial response.

Invoking the LLM With One or More Prompts. In some embodiments, the AI assistant constructs one or more prompts for invoking the LLM. This could be a single prompt or multiple prompts (two or more, e.g. a series of prompts given to the LLM). The one or more prompts comprise the user's query, user status attributes, the relevant permission regulations, and optionally, retrieved knowledge documents. The AI assistant invokes the LLM with the prompt(s). The output response generated by the LLM may be given directly to the user as the moderated response. Or alternatively, the output response may undergo further post-processing to generate the moderated response that is given to the user.

Permission Regulations. The AI assistant retrieves the user's attributes from the user profile database. The AI assistant also works with a permission database (e.g. managed by a policy administration point) that comprises permission regulations (e.g. rules, policies, guidelines, norms, etc.) that establishes different levels of user access to the knowledge repository. The permission regulations could define user access privileges according to topics or types of information, such as financial information, technical information (e.g. product specifications or software code), employee information, etc.

The permission regulations could be expressed in natural human language (as opposed to a language that is adapted for machine reading). An example permission regulation expressed in natural human language is: “Only people in the sales department or company executives have a need-to-know for company sales information.” Or expressed as a negative rule (i.e. denial of access): “A marketing intern does not have a need-to-know for company sales information.” Having the permission regulations written in natural human language has the advantage of being easily understood by humans doing access reviews. Also, this could facilitate having the same ‘need-to-know’ configurations be applied across different resources (e.g. different knowledge storage sites, different applications or apps, etc.).

Based on the user's status attributes and the user query, the AI assistant invokes the LLM to identify permission regulations from the permission database that are relevant to the user. This could be used as context in generating the moderated response to the user's query.

User Activities. The AI assistant may analyze the knowledge repository to learn the user's work activities. Examples of documents in the knowledge repository whose content could indicate the user's activities include emails, online chats, group messages, meeting invitations or attendance, teleconference calls, video calls, etc. This analysis could be performed as follows. Retrieve documents in the knowledge repository in which the user is a participant (e.g. sender or receiver in emails or messages). Invoke the LLM with the retrieved activity documents and instruct the LLM to identify the user's activities therefrom. The LLM outputs the identified user's activities. The moderating context or the one or more prompts to the LLM may comprise the identified user's activities.

Working Hierarchy. The organization may have a formal hierarchy of which the user has a position therein. The AI assistant may analyze the knowledge repository to learn the user's position in the organization's actual working hierarchy (which is different from the formal hierarchy). This analysis could be performed as follows. Retrieve documents in the knowledge repository in which the user is a participant. Invoke the LLM with the retrieved activity documents and instruct the LLM to identify the user's interactions with others in the organization. The LLM outputs the identified user's interactions. The moderating context or the one or more prompts to the LLM may comprise the identified user's interactions.

Job Objective. The AI assistant may analyze the knowledge repository to learn the user's job objectives and the topics of knowledge for which the user requires access privilege in order to achieve the job objectives. This analysis could be performed as follows. Retrieve documents in the knowledge repository in which the user is a participant. Invoke the LLM with the retrieved activity documents and instruct the LLM to identify job objectives of the user. The LLM outputs the identified job objectives. Invoke the LLM again with instructions to identify knowledge topics that are relevant to the user's job objectives. The LLM outputs the identified knowledge topics. The moderating context or the one or more prompts to the LLM may comprise the identified job objectives or the identified knowledge topics.

Computerized System. In another aspect, this invention is a computerized system that implements the methods described herein. As conventional in computerized systems, the computerized system comprises one or more storage memory, one or more processors, and instruction code stored in the storage memory(s) that is executable by the processor(s) and configured to cause the processor(s) to perform a computer-implemented method described herein.

In some embodiments, the computerized system comprises: one or more processors; and one or more storage memories that hold instructions executable by the processor(s) to perform a process that comprises the following steps. Provide an AI assistant that comprises a large language model (LLM). Access a knowledge repository comprising documents that represent the organization's knowledge base. Access a user profile database that comprises status attributes of users of the AI assistant. Receive a query to the AI assistant from a user, wherein the user has status attributes contained in the user profile database. Invoke the LLM with the query and supplemental context to generate an initial response to the query, wherein the supplemental context comprises contextual documents retrieved from the knowledge repository. Generate a moderated response to the query by a moderating process that comprises invoking the LLM with an instruction to restate the initial response with moderating context that comprises the user's status attributes. Give the moderated response to the user, wherein the moderated response is different from the initial response.

In some embodiments, the computerized system comprises: one or more processors; and one or more storage memories that hold instructions executable by the processor(s) to perform a process that comprises the following steps. Provide an AI assistant that comprises a large language model (LLM). Access a knowledge repository comprising documents that represent the organization's knowledge base. Access a user profile database that comprises status attributes of users of the AI assistant. Access a permission database that comprises permission regulations that establish different levels of user access to the knowledge repository. Receive a query to the AI assistant from a user, wherein the user has status attributes contained in the user profile database. Retrieve the user's status attributes from the user profile database. Retrieve permission regulations from the permission database based on the user's status attributes. Create one or more prompts comprising the query, user's status attributes, and the retrieved permission regulations. Invoke the LLM with the one or more prompts. Generate a moderated response to the query. Give the moderated response to the user.

### BRIEF DESCRIPTION OF THE DRAWINGS

FIG. 1 shows a schematic illustration of an example AI assistant that moderates responses given to user queries.

FIG. 2 shows an example flow process for generating moderated responses to user queries.

FIGS. 3A and 3B show examples of an organization's hierarchy.

FIG. 4 shows examples of how information useful for moderating a query response could be learned from a user's activity documents.

### DETAILED DESCRIPTION OF EXAMPLE EMBODIMENTS

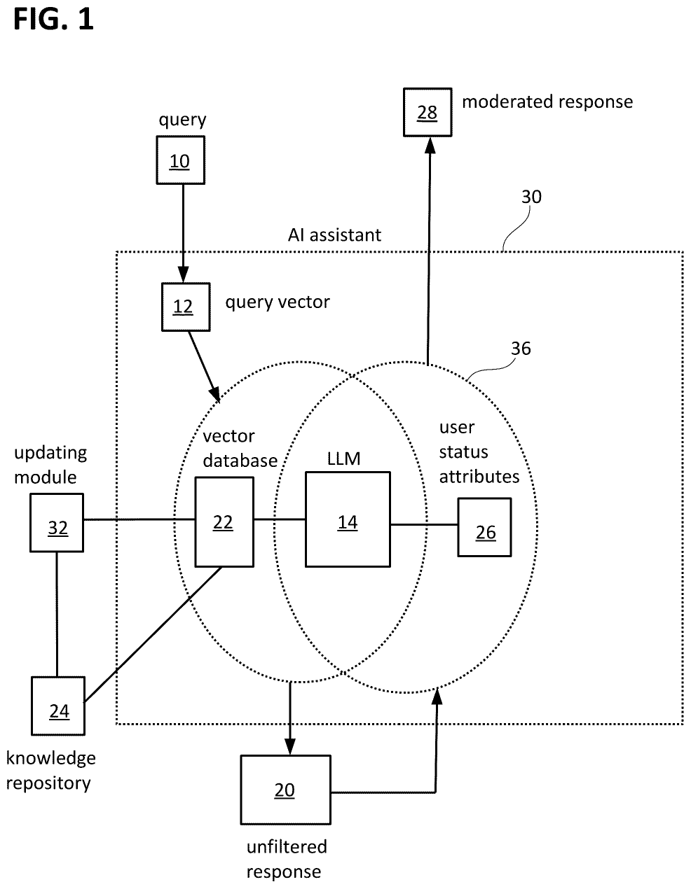

Drawings are provided to help understand the invention and illustrate specific representative examples. FIG. 1 shows an example of how the invention could be implemented. In this example, the institution is a business enterprise that has an AI virtual assistant 30 that comprises an LLM 14 that is trained on a large body of public data. The employees of the company are provided with access to the AI assistant 30 as a tool to help perform their work tasks.

The company also has a large body of institutional knowledge that comes from various sources (e.g. emails, group messages, memos, letters, software code, training manuals, etc). These items are captured and stored as electronic documents in a knowledge repository 24 that contains the current knowledge base (stored as electronic documents) of the company. The many documents of knowledge repository 24 are encoded as numeric vectors (by a conventional embedding process) that represent the contents of the documents. These document vectors are stored in a vector database 22. AI assistant 30 uses vector database 22 to augment already-trained LLM 14 as supplemental context for answering queries.

In this particular example, the user is a marketing intern who poses a question about the company. The marketing intern has access to a very limited subset of the contents of knowledge repository 24. The marketing intern makes a query 10 to AI virtual assistant 30 as follows: “What do this coming quarter's sales numbers look like?” AI assistant 30 converts query 10 into a numeric vector 12 as a representation of query 10. With query vector 12, AI assistant 30 then performs vector searching of vector database 22 (which indexes the documents of knowledge repository 24). AI assistant 30 compares query vector 12 against the document vectors stored in vector database 22.

AI assistant 30 finds the documents that are most relevant to query 10 based on the similarity of query vector 12 to the document vectors in vector database 22. Having a selection of the most relevant documents, AI assistant 30 then retrieves the selected documents from knowledge repository 24. AI assistant 30 then invokes LLM 14 with a prompt containing user query 10 and further in the context of the selected documents. In reply, LLM 14 generates a full unfiltered response 20, which is as follows: “Our projected revenue for this coming quarter is $120 MM.”

However, the marketing intern does not have a ‘need-to-know’ justification for this unfiltered response 20 given their limited access to the company's knowledge base. Thus, AI assistant 30 does not display unfiltered response 20 to the marketing intern. Also, AI assistant 30 does not simply reply with the answer “Access Denied”. Instead, moderating engine 36 in AI assistant 30 moderates response 20 so that it is appropriate for the marketing intern's lower level of ‘need-to-know’ access privilege and would be helpful in accomplishing legitimate business tasks.

Moderating engine 36 determines how to moderate unfiltered response 20 according to the user's status attributes that determine their need-to-know privileges. Each user of AI assistant 30 has status attributes associated with the user's status in the company. In this example, the marketing intern's status attributes include existing access privileges and position of ‘marketing intern’ along with the designation of working in the sales & marketing department and part of a particular product team. These status attributes are not under the direct control of the user. This prevents intentional manipulation to elevate their access permissions. These user status attributes are stored in a database 26 (e.g. as a human-readable dossier or embedded as numeric vectors). Here, database 26 is separate from knowledge repository 24. But in an alternate embodiment, knowledge repository 24 comprises database 26 (i.e. database 26 is part of knowledge repository 24).

AI assistant 30 then invokes LLM 14 with a prompt that includes instructions to restate unfiltered response 20 in the context of the marketing intern's status attributes. In reply, LLM 14 generates a moderated response 28 as follows: “Marketing campaigns A & C are significantly contributing to increased sales for this coming quarter.” Thus, the marketing intern is given an informative response to query 10, but with vagueness appropriate for the lower tier access privilege and yet with sufficient specificity to assist with performance of legitimate work tasks.

As a further example to demonstrate a contrast, another user is the company CEO, who has the highest level of privilege to the company's knowledge base. For hypothetical demonstration of how this invention operates, the CEO makes a query that is identical to query 10 (see above) to AI virtual assistant 30. This query is processed in the same manner as described above to generate the same unfiltered response 20 (see above). However, recognizing the company CEO's status as having full ‘need-to-know’ access privilege, AI assistant 30 displays the full unfiltered response 20 (instead of a moderated response). Note that in both instances, AI assistant 30 uses the same LLM 14 and the same vector database 22 that is an embedding of the same knowledge repository 24. However, the marketing intern receives a substantially different answer than the company CEO to the exact same query 10. The system further comprises an updating module 32 that continuously updates vector database 22 according to new or revised documents in knowledge repository 24.

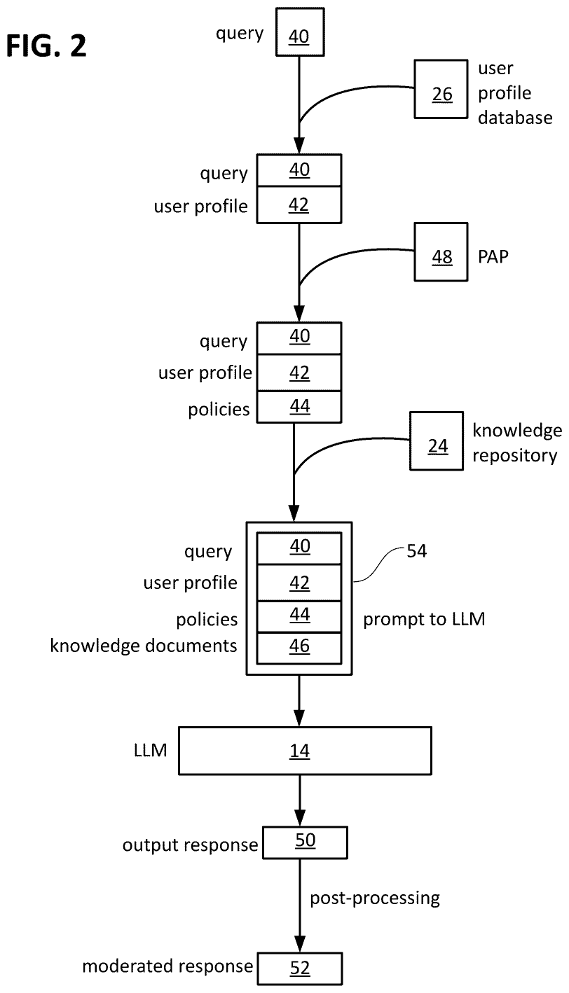

FIG. 2 shows another example of how an AI assistant of this invention could operate. The user makes a query 40 to the AI assistant. From this user query 40, the AI assistant creates a prompt 54 for LLM 14. Prompt 54 is created by appending various context items to query 40. The AI assistant retrieves the particular user's profile 42 from user database 26 and appends that to query 40. The AI assistant further retrieves relevant policies 44 from a policy administration point (PAP) 48 and also appends that to query 40. The AI assistant further retrieves knowledge documents 46 from knowledge repository 24 that are relevant to query 40 (and suitable for the user's profile 42). The AI assistant appends the retrieved knowledge documents 46 to query 40. This results in prompt 54, which contains query 40, plus user profile 42, policies 44 that are relevant to user profile 42, and relevant documents 46 as context items for replying to query 40. The AI assistant then invokes LLM 14 with prompt 54. This generates an output response 50. This output response 50 goes through further post-processing to refine and enhance output response 50 (e.g. correcting inconsistencies, removing redundant information, rephrasing awkward expressions, etc). This results in a moderated response 52 that is given to the user in reply to user query 40.

In an alternate embodiment, query 40, user profile 42, policies 44, and knowledge documents 46 are presented to LLM 14 in multiple prompts. For example, LLM 14 could be invoked with query 40 as grounded with knowledge documents 46 as a first prompt. This could be followed by a second prompt that contains user profile 42 and policies 44.

In an alternate design configuration, LLM 14 is pretrained on knowledge repository 24. In this design, LLM 14 could directly fetch the relevant data from pre-indexed documents. For this design, prompt 54 contains query 40, plus user profile 42 and policies 44 as context items for replying to query 40.

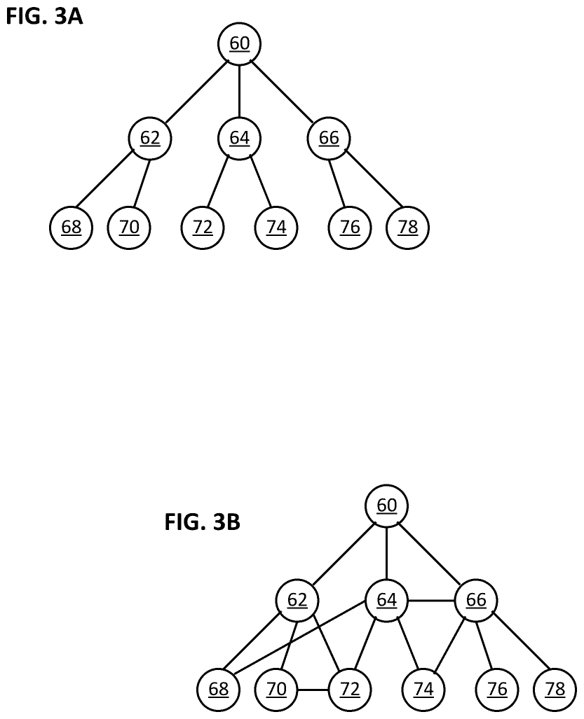

To demonstrate an example of how the AI assistant could determine a particular user's ‘need-to-know’ privilege within a hierarchy, FIG. 3A shows an example of a formal hierarchy among the employees of an organization. At the top of the hierarchy is the executive committee 60. In the middle are the team managers 62, 64, and 66. At the bottom are the individual team members 68, 70, 72, 74, 76, and 78. The lines represent the sharing of information between the employees within the hierarchy. As seen here, the sharing of information adheres to the formal hierarchy pattern.

The AI assistant performs an analysis of the knowledge repository, user profiles, and employee communications to discover the actual working hierarchy of the organization as shown in FIG. 3B. The actual working hierarchy shows that there are more information sharing interactions than what is formally acknowledged by the formal hierarchy. Strictly following the formal hierarchy for information flow could impede the appropriate dissemination of need-to-know information among the employees.

For example, for team member 72 formally has information sharing privileges with only team manager 64 according to the formal hierarchy. However, the actual working hierarchy better represents the need-to-know information flow among the employees. Thus, team member 72 should also have access privilege to certain types of information known by team manager 62 and team member 70, who are outside the formal hierarchy for team member 72.

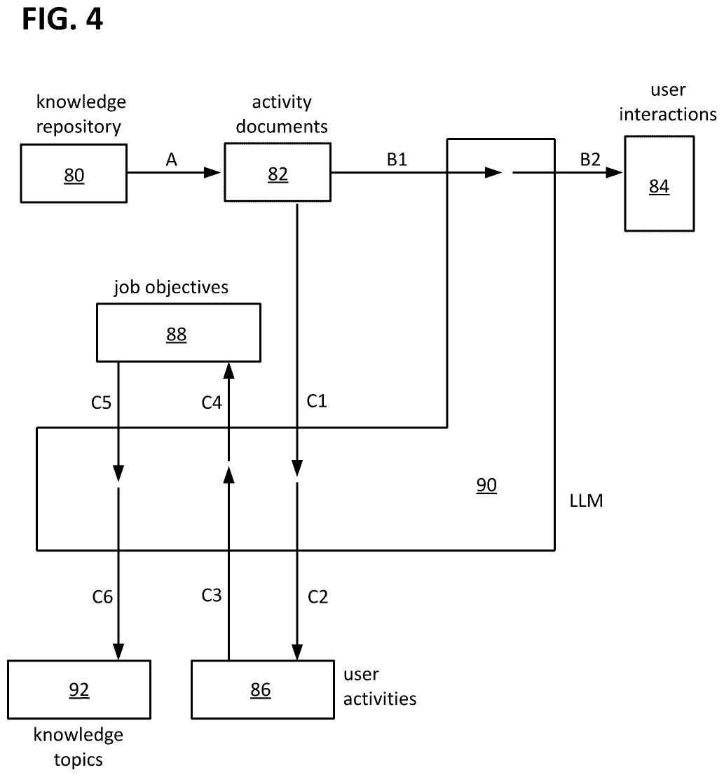

FIG. 4 shows examples of how information useful for moderating a query response could be learned from the user's activity documents 82. In step A, documents in knowledge base 80 in which the user is a participant (e.g. author, sender, recipient, etc.) are identified and retrieved. See user activity documents 82. In step B1, activity documents 82 are fed into LLM 90 with instructions to analyze them and identify (e.g. summarize) the user's interactions therefrom. This may be useful for discovering the user's position within the organization's actual working hierarchy. In step B2, LLM 90 outputs the identified user interactions 84, which are then considered in generating a response to the user's query.

Activity documents 82 may also be used for other purposes, such as identifying topics of knowledge for which the user should have access privileges. In step C1, activity documents 82 are fed into LLM 90 with instructions to analyze them and identify the user's activities therefrom. In step C2, LLM 90 outputs the identified user activities 86. In step C3, user activities 86 are fed into LLM 90 with instructions to identify the user's job objectives from user activities 86. In step C4, LLM 90 outputs the identified job objectives 88, which may then be considered in generating a response to the user's query. Further, in step C5, job objectives 88 are fed into LLM 90 with instructions to identify topics of knowledge that are relevant to carrying out job objectives 88. In step C6, LLM 90 outputs the identified topics 92 (i.e. topics for which the user has ‘need-to-know’ privileges).

The description above is not intended to indicate exclusive system elements or exclusive action steps (unless specifically indicated otherwise) for the operation of the invention. Where system elements or method steps are described, this is not a limitation to only what is explicitly mentioned (unless specifically indicated otherwise). For example, where the description indicates that moderated response 28 is made according to the marketing intern's status attributes in database 26, that does not mean that only the user's status attributes are considered in making moderated response 28. AI assistant 30 may consider other factors in making moderated response 28 (such as user activities). In another example, where the description indicates that vector database 22 is used to provide supplemental context, other information may also provide supplemental context. In another example, where the description indicates that knowledge repository 24 contains documents, it may contain other types of data information that could also be used by AI assistant 30 to provide the supplemental context.

The foregoing description and examples merely illustrate the invention and are not intended to be limiting. Each of the disclosed aspects and embodiments of the invention may be considered individually or in combination with other aspects, embodiments, and variations of the invention. Also, unless otherwise specified, the steps of the methods of the invention are not limited to any particular order of performance. Persons skilled in the art may perceive modifications to these embodiments that incorporate the spirit and substance of the invention. Such modifications are within the scope of the invention.

Any use of the word “or” herein is intended to be inclusive and is equivalent to the expression “and/or,” unless the context clearly indicates otherwise. As such, for example, the expression “A or B” means A, or B, or both A and B. Similarly, for example, the expression “A, B, or C” means A, or B, or C, or any combination thereof.

1. A computer-implemented method for handling queries to an artificial intelligence (AI) assistant in the setting of an organization, the method comprising:
having a knowledge repository comprising documents that represent the organization's knowledge base;
having an AI assistant that comprises a large language model (LLM);
having a user profile database that comprises status attributes of users of the AI assistant;
receiving a query to the AI assistant from a user, wherein the user has status attributes contained in the user profile database;
invoking the LLM with the query and supplemental context to generate an initial response to the query, wherein the supplemental context comprises contextual documents retrieved from the knowledge repository;
generating a moderated response to the query by a moderating process that comprises invoking the LLM with an instruction to restate the initial response with moderating context that comprises the user's status attributes;
giving the moderated response to the user, wherein the moderated response is different from the initial response.

2. The method of claim 1, wherein the initial response is not given to the user.

3. The method of claim 1, further comprising:
having a vector database comprising document vectors for the documents in the knowledge repository;
converting the query into a query vector;
comparing the query vector to the document vectors in the vector database;
based on the comparison, selecting the contextual documents;
retrieving the contextual documents from the knowledge repository.

4. The method of claim 1, wherein the moderating process further comprises:
receiving an output response from the LLM;
performing post-processing on the output response to generate the moderated response.

5. The method of claim 1, further comprising:
retrieving user activity documents in the knowledge repository in which the user is a participant;
invoking the LLM with the retrieved user activity documents with an instruction to identify the user's activities therefrom;
wherein the LLM outputs the identified user's activities, and wherein the moderating context further comprises the identified user's activities.

6. The method of claim 5, further comprising:
invoking the LLM with an instruction to identify job objectives of the user from the retrieved user activity documents, wherein the LLM outputs the identified job objectives;
invoking the LLM with an instruction to identify knowledge topics that are relevant to the identified job objectives;
wherein the LLM outputs the identified knowledge topics, and wherein the moderating context further comprises the identified knowledge topics.

7. The method of claim 1, further comprising:
retrieving user activity documents in the knowledge repository in which the user is a participant;
invoking the LLM with the retrieved user activity documents with an instruction to identify the user's interactions therefrom;
wherein the LLM outputs the identified user's interactions, and wherein the moderating context further comprises the identified user's interactions.

8. The method of claim 1, wherein the moderating context further comprises permission regulations that are relevant to the user, wherein the permission regulations are expressed in natural human language.

9. The method of claim 5, wherein the retrieved user activity documents include an email or message in which the user is a recipient or sender.

10. The method of claim 7, wherein the retrieved user activity documents include an email or message in which the user is a recipient or sender.

11. A computer-implemented method for handling queries to an artificial intelligence (AI) assistant in the setting of an organization, the method comprising:
having an AI assistant that comprises a large language model (LLM);
having a knowledge repository comprising documents that represent the organization's knowledge base;
having a user profile database that comprises status attributes of users of the AI assistant;
having a permission database that comprises permission regulations that establish different levels of user access to the knowledge repository;
receiving a query to the AI assistant from a user, wherein the user has status attributes contained in the user profile database;
retrieving the user's status attributes from the user profile database;
retrieving permission regulations from the permission database based on the user's status attributes;
creating one or more prompts comprising the query, user's status attributes, and the retrieved permission regulations;
invoking the LLM with the one or more prompts;
generating a moderated response to the query;
giving the moderated response to the user.

12. The method of claim 11, further comprising:
receiving an output response from the LLM;
performing post-processing of the output response to result in the moderated response.

13. The method of claim 11, further comprising using the query to retrieve contextual documents from the knowledge repository; wherein the one or more prompts further comprises the retrieved contextual documents.

14. The method of claim 11, wherein the permission regulations are expressed in natural human language.

15. The method of claim 11, further comprising:
retrieving user activity documents in the knowledge repository in which the user is a participant;
invoking the LLM with the retrieved user activity documents with an instruction to identify the user's activities therefrom;
wherein the LLM outputs the identified user's activities, and wherein the one or more prompts further comprises the identified user's activities.

16. The method of claim 15, further comprising:
invoking the LLM with an instruction to identify job objectives of the user from the retrieved user activity documents, wherein the LLM outputs the identified job objectives;
invoking the LLM with an instruction to identify knowledge topics that are relevant to the job objectives;
wherein the LLM outputs the identified knowledge topics, and wherein the one or more prompts further comprises the identified knowledge topics.

17. The method of claim 11, further comprising:
retrieving user activity documents in the knowledge repository in which the user is a participant;
invoking the LLM with the retrieved user activity documents with an instruction to identify the user's interactions therefrom;
wherein the LLM outputs the identified user's interactions; wherein the one or more prompts further comprises the identified user's interactions.

18. A computerized system for handling queries to an artificial intelligence (AI) assistant in the setting of an organization, the system comprising:
one or more processors; and
one or more storage memories that hold instructions executable by the processor(s) to perform a process that comprises:
providing an AI assistant that comprises a large language model (LLM);
accessing a knowledge repository comprising documents that represent the organization's knowledge base;
accessing a user profile database that comprises status attributes of users of the AI assistant;
accessing a permission database that comprises permission regulations that establish different levels of user access to the knowledge repository;
receiving a query to the AI assistant from a user, wherein the user has status attributes contained in the user profile database;
retrieving the user's status attributes from the user profile database;
retrieving permission regulations from the permission database based on the user's status attributes;
creating one or more prompts comprising the query, user's status attributes, and the retrieved permission regulations;
invoking the LLM with the one or more prompts;
generating a moderated response to the query;
giving the moderated response to the user.

19. The computerized system of claim 18, wherein the process further comprises:
retrieving user activity documents in the knowledge repository in which the user is a participant;
invoking the LLM with the retrieved user activity documents with an instruction to identify the user's activities therefrom;
wherein the LLM outputs the identified user's activities, and wherein the one or more prompts further comprises the identified user's activities.

20. The computer system of claim 19, wherein the process further comprises:
invoking the LLM with an instruction to identify job objectives of the user from the retrieved user activity documents, wherein the LLM outputs the identified job objectives;
invoking the LLM with an instruction to identify knowledge topics that are relevant to the job objectives;
wherein the LLM outputs the identified knowledge topics, and wherein the one or more prompts further comprises the identified knowledge topics.
